(19) United States
(12) Patent Application Publication
(10) Pub. No.: US 2021/0023666 A1
(43) Pub. Date: Jan. 28, 2021

(54) AUTO LOADING & UNLOADING SYSTEM AND METHOD FOR DOUBLE SPINDLE CNC MACHINES

(71) Applicant: Siddhant Sarup, Ludhiana, Punjab (IN)

(72) Inventors: Siddhant Sarup, Ludhiana (IN); Gaurav Sarup, Ludhiana (IN); Prashant Sarup, Ludhiana (IN)

(21) Appl. No.: 16/977,824

(22) PCT Filed: Oct. 30, 2018
(86) PCT No.: PCT/IN2018/050699

§ 371 Date: Sep. 3, 2020

(30) Foreign Application Priority Data
Mar. 5, 2018 (IN) 201811008029

(51) Int. Cl. B23Q 7/04

(52) U.S. Cl. CPC B23Q 7/048; B23Q 7/043; B23Q 2039/008; B23Q 2707/003; B23Q 7/041

(57) ABSTRACT

The present invention provides an automatic loading and unloading system and method for double spindle CNC machines. The system makes use of cross slide component of the CNC machine itself and its sliding movements to perform loading and unloading a finished job from the machine, and eliminating need of external robots/gantry. The system comprises two sets of twin grippers placed at the two cross slides across the two spindles. Each set of grippers perform pickup, unload, load and ejection of jobs. A transfer arm travels between the two spindles to transfer semi-finished jobs between the spindles, in order to finish the jobs and collect them in an out-feed bin. The present system provides simpler and faster way of loading and unloading jobs automatically.

### FIELD OF THE INVENTION

The present invention is generally related to CNC machines. More particularly, the present invention is related to a method and system for automatic loading and unloading of jobs in twin spindle CNC Lathe machines.

### BACKGROUND OF THE INVENTION

CNC machines are widely used for manufacturing parts or components, since these machines automate the manufacturing process by implementing computer generated design and directives. The machines need raw jobs to be loaded and finished jobs to be unloaded from them to continue the process without any interruptions. Conventional methods for loading and unloading involve human operators for some CNC machines; while others involve robot or gantry systems for automate the loading and unloading process. Having human operators for loading systems are considered inefficient and also dangerous.

Conventional automatic loading and unloading systems include gantry loading systems which are compatible with CNC lathe machines. Such gantry systems come in various sizes with single or twin multiple axis gantry arms. In some of the systems, the arms are accessorized with a pneumatically operated gripper. Further, such loading systems are also guarded with safety doors or light curtains that need to be opened whenever the gantry arms enter machine enclosures to loador unload a job. A usual way of these loading systems include the gantry arm/robot unloading a finished job, loading a new job, coming out of the door and dropping the finished job at a designated point.

Such existing auto loading methods and systems use complex CNC controlled machines (Robot or Gantry). The implementation of the machine doors to allow entry of the gantry arms into the machine enclosures, in turn, requires time and energy and also allows escape of a coolant mist when the door opens. This escaped coolant mist is a loss of money and also spreads dampness in the area around machine.

Therefore, there exists a need for automatic loading and unloading systems in the CNC machines which is simpler, faster and efficient, and does not allow the coolant mist to be escaped, hence helps in saving money.

### SUMMARY OF INVENTION

Hence, it is an objective of the present invention to provide an innovative and efficient way of unloading machined jobs, picking up and loading new jobs and removing machined jobs from the CNC machines.

It is an objective of the present invention to provide an auto loading system and method for CNC machines that ensures entry of new jobs into machine enclosures and exit of finished jobs from the enclosure through small cavities/openings which eliminate necessity of having a door and its opening.

It is another objective of the present invention to provide an auto loading system and method for CNC machines that exploits the CNC machine's cross slide movements only, to eliminate need for external machines like Robot or Gantry for loading & unloading, making the design of the system simpler.

It is a yet another objective of the present invention to design an auto loading system which eliminates opening of doors of the CNC machines and hence, does not allow the coolant mist to escape from the machine enclosure.

It is another objective of the present invention to develop an automatic loading and unloading system for a twin spindle CNC machine that efficiently unloads a machined job and loads a new job into chuck.

### BRIEF DESCRIPTION OF ACCOMPANYING DRAWINGS

For a better understanding of the embodiments of the systems and methods described herein, and to show more clearly how they may be carried into effect, references will now be made, by way of example, to the accompanying drawings, wherein like reference numerals represent like elements/components throughout and wherein:

FIG. 1 illustrates a block diagram of an exemplary environment including a twin spindle CNC lathe machine employing an auto loading system of the present invention, in accordance with an embodiment of the present invention;

FIG. 2 illustrates a flow chart showing a method employing the auto loading system in a CNC machine with double spindles, in accordance with an embodiment of the present invention; and

FIGS. 3-9 illustrates an exemplary environment showing a double spindle CNC lathe machine with auto loading system including the two sets of twin grippers performing the job handling operations of pickup, load, unload and eject, in accordance with an embodiment of the present invention.

### DETAILED DESCRIPTION OF INVENTION

This patent describes the subject matter for patenting with specificity to meet statutory requirements. However, the description itself is not intended to limit the scope of this patent. The principles described herein may be embodied in many different forms.

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The present invention provides an automatic loading and unloading system and method to be employed in CNC machines. More particularly, the present invention provides an automatic loading and unloading system and method for twin spindle CNC machines. In an embodiment, the CNC machine is a twin spindle CNC lathe machine. It may be appreciated by a person skilled in the art that the present invention may also be used for other CNC machines such as Multi Axis CNC Lathes, Multi Spindle CNC Lathes, and others without deviating from the meaning and scope of the present invention. For the purposes of clarity and simplicity, in the further description, the ‘automatic loading and unloading system and method’ of the present invention is interchangeably referred to as ‘auto loading system’, without deviating from the meaning and scope of the present invention.

The auto loading system for the twin spindle CNC machine comprises two sets of twin preset grippers, one for each spindle; and a transfer arm to transfer semi-finished job between the two spindles of the machine. The grippers are placed at top end and bottom end of a Cross Slide (X Axis) of the CNC machine. The movement of the grippers is controlled by the Slide movement which is controlled by CNC. Therefore, the system uses the slide component of the CNC machine itself and exploits its sliding movements to perform job handling operations, which includes picking a raw job, unloading the semi-machined job, load the raw job into chuck of the first spindle and load the semi-machines job in the transfer arm which further puts the semi-machined job in a pickup zone of the second spindle. From there, the fully machined job is ejected and is dropped in an out-feed bin. Using the sliding movements of the CNC machine itself, eliminates the need of having any external robotic/gantry arm.

The auto load system uses the two sets of the twin grippers to complete the above job handling operations in only TWO actions for each set of grippers; at the first spindle, a first and a second grippers simultaneously, first, pick a new job from a pickup zone AND unload a semi-finished job from a first chuck of the first spindle; and second load the new job in the first chuck and drop the semi-finished job in the transfer arm, simultaneously. The transfer arm puts the semi-finished job in the pickup zone of the second spindle. Thereafter, at the second spindle, third & fourth grippers simultaneously, first pick the semi-finished job from the pickup zone of the second spindle, and unload a fully finished (or finished) job from a second chuck of the second spindle; and second, load the semi-finished job in the second chuck and drop the finished job into a part ejector. From the part ejector, the finished jobs are collected in the out-feed bin outside the CNC machine. This offers a simple and a faster way of auto loading and unloading jobs from the twin spindle CNC machines. It may be apparent to a person skilled in the art that the auto loading system may use a variety of suitable job handling tools, including the twin grippers, depending on the design and requirement of the CNC machine, without deviating from the meaning and scope of the present invention. It may also be apparent to a person skilled in the art that the present auto loading system may be applied to a variety of CNC machines, such as Lathes, Milling, Gear Cutting, Grinding and others.

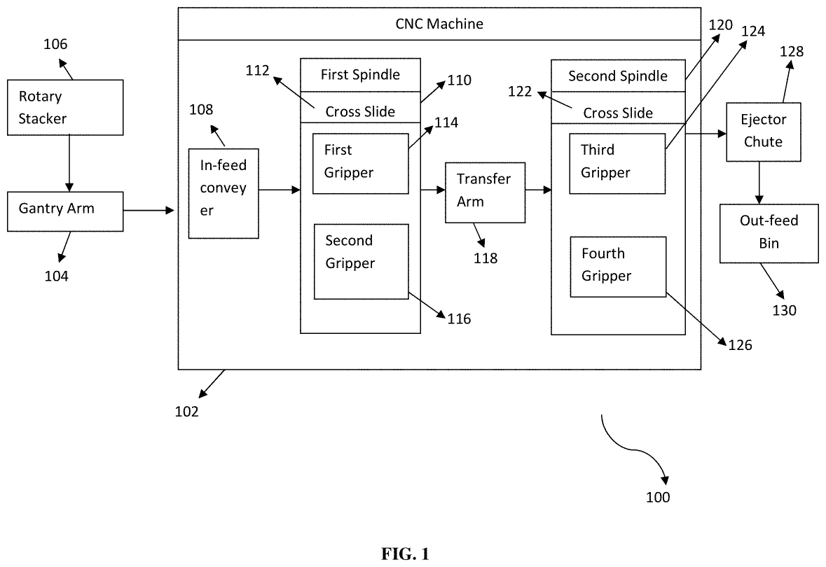

FIG. 1 illustrates a block diagram of an exemplary environment including a twin spindle CNC lathe machine employing the auto loading system of the present invention, in accordance with an embodiment of the present invention. The system 100 has a CNC lathe machine 102 that includes a gantry arm 104 for picking up raw jobs to be loaded in the CNC machine 102; a stacker (or any other suitable infeed system including Vibratory Bowl Feeder) 106 on which the raw jobs are stacked to be picked up by the gantry arm 104; an in-feed conveyer 108 that feeds the raw jobs into the machine 102; a first spindle 110 with a first cross slide 112 which is installed with a set of twin grippers including a first gripper 114 and a second gripper 116; a transfer arm 118; a second spindle 120 with a second cross slide 122 which is also installed with a set of twin grippers including a third gripper 124 and a fourth gripper 126; where the sets of twin grippers are for gripping or holding the jobs while in the machine 100. It may be appreciated by a person skilled in the art that the CNC machine 102 may have other suitable in-feed system than the present rotary stacker 106 depending on the requirement and design of the machine 102, without deviating from the meaning and scope of the present invention.

The CNC machine further includes an ejector chute 128 from which a finished job is ejected out from the machine towards an out-feed bin 130. The sets of grippers (114, 116 and 124, 126) are installed at the top end and bottom end of the first 112 and second 122 Cross Slides (X Axis) respectively. Their movement of picking up jobs from pickup zone and chuck simultaneously is controlled by a Slide movement which is controlled by the CNC.

In a preferred embodiment as shown in the FIG. 1, the CNC machine is a double spindle machine with two spindles: each with one chuck for turning, and each with one set of twin grippers to load raw jobs and unload finished jobs. In operation, the gantry arm 104 picks up a raw job from the stacker (or any other suitable infeed system including Vibratory Bowl Feeder) or any other in-feed device 106 and places it on the in-feed conveyer 108. The in-feed conveyer 108, further, puts the raw job in a first pickup zone of the first spindle, where it is picked by the first gripper 114. The machine102 has the sets of twin grippers working and performing the job handling operations of pickup, unload, load and eject. The CNC machine 102 has two spindles each with a chuck attached to it, from where the semi- and fully finished jobs are unloaded simultaneously, of the raw jobs being picked up from the pickup zones. Both the chucks work at the same time as raw jobs are being fed to them simultaneously.

After the in-feed conveyer 108 puts the raw job into the first pickup zone of the first spindle, the first cross slide 112 slides and brings the first gripper 114 close to the pickup zone, while the second gripper 116 close to the chuck. The first gripper 114 picks the raw job, while the second gripper 116 unloads a semi-finished job from the chuck of the first spindle 110 simultaneously. After this, the cross slide 112 slides, so that the first gripper 114 loads the raw job into the chuck, while the second gripper 116 puts the semi-finished job in the transfer arm 118. Further, the transfer arm 118 travels to the other side of the machine 102, where the second spindle 120 is situated. The transfer arm 118 drops the semi-finished job into a roof mounted chute, from where the semi-finished job is put in a second pickup zone of the second spindle 120. Thereafter, the second cross slide 122 slides to move the third gripper 124 close to the second pickup zone and the fourth gripper 126 close to second chuck of the second spindle 120. Consequently, the third gripper 124 picks the semi-finished job from the second pickup zone, while the fourth gripper 126 unloads a fully finished job from the second chuck simultaneously.

Afterwards, the second cross slide 122 slides so that the third gripper 124 loads the semi-finished job in the second chuck, while the fourth gripper 126 drops the finished job into the ejector chute 128. The second chuck works on the semi-finished job to finish it, where the finished job slides through the ejector chute 128 and reaches the out-feed bin 130 where it is collected out from the CNC machine 102.

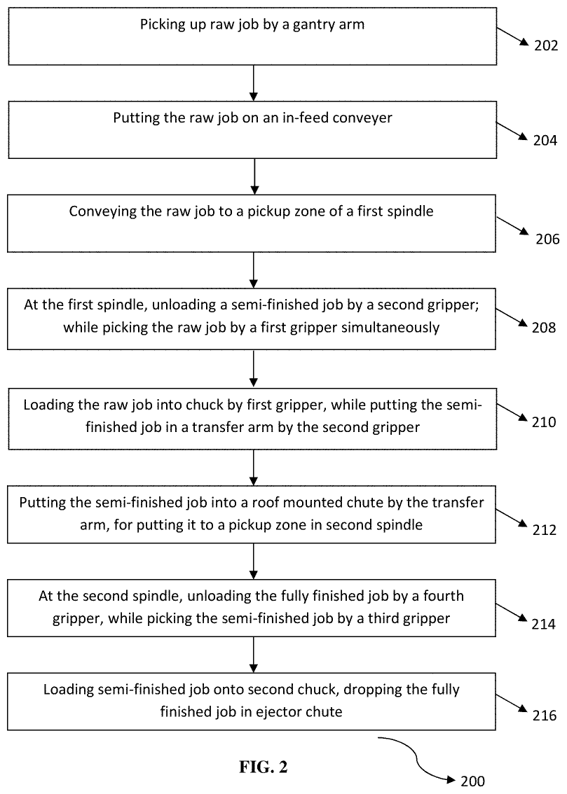

FIG. 2 illustrates a flow chart showing a method employing the auto loading system in a CNC machine with double spindles, in accordance with an embodiment of the present invention. The method 200 shows a step 202where the gantry arm104 picks up a ram job from the rotary stacker 106. At step 204, the gantry arm 104 puts the raw job onto the in-feed conveyer 108, which in turn, at step 206, conveys the raw job to a first pickup zone of the first spindle 110. Thereafter, at the first spindle 110, the first cross slide 112 slides to a position when the first gripper 114 and the second gripper 116 come close to the first pickup zone and the first chuck of the first spindle 110, respectively. Hence, the first spindle 114 picks up the raw job from the first pickup zone, while the second gripper 116 unloads the semi-finished job from the first chuck, simultaneously, at step 208. After this, the cross slide 112 slides to a position, where the first gripper 114 loads the raw job into the first chuck, while the second gripper 116 puts the semi-finished job in the transfer arm 118, at step 210.

The transfer arm 118, then, travels to the other side of the machine 102, where the second spindle 120 is situated. At step 212, the transfer arm 118 puts the semi-finished job in to the roof mounted chute that further puts the semi-finished job into the second pickup zone of the second spindle 120. It may be appreciated by the person skilled in the art, that the machine 102 may have different types of other chutes, for carrying the semi-finished jobs to the second pickup zone, depending on the design and requirement of the machine 102, without deviating from the meaning and scope of the present invention. Thereafter, the second cross slide 122 slides, so that the third gripper 124 and the fourth gripper 126 come close to the second pickup zone and the second chuck of the second spindle 120, respectively. Now at the second spindle 120, the third gripper 124 picks the semi-finished job from the second pickup zone, while the fourth gripper 126 unloads a fully finished job from the second chuck simultaneously, at step 214. Further, at step 216, the third gripper 124 loads the semi-finished job onto the second chuck, while the fourth gripper 126 drops the finished job into the ejector chute 128 simultaneously. Consequently, the finished job slides through the ejector chute 128 and reach the out-feed bin 130, from where the finished job is collected.

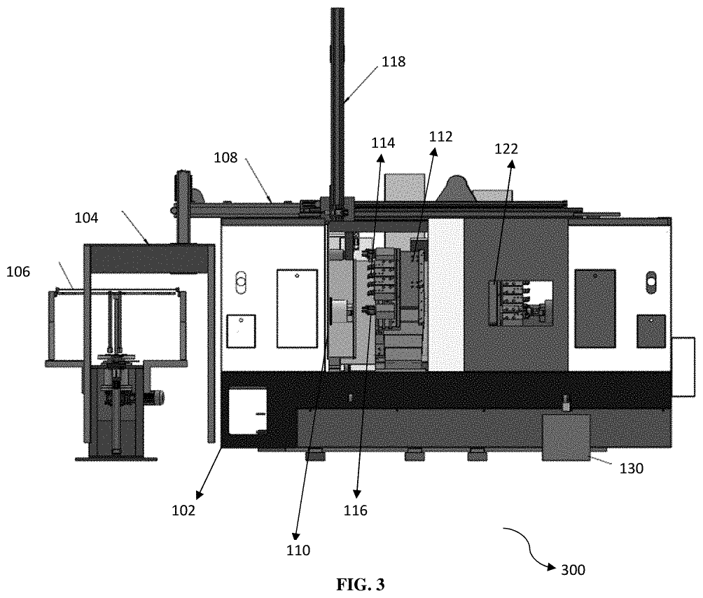

FIGS. 3-9 illustrates an exemplary environment showing a double spindle CNC lathe machine with auto loading system including the two sets of twin grippers performing the job handling operations of pickup, load, unload and eject, in accordance with an embodiment of the present invention. FIG. 3 shows an environment 300 including the CNC lathe machine 102. The machine 102 includes the components gantry arm 104; the rotary stacker 106; the in-feed conveyer 108; the first spindle 110; the first cross slide 112 that slides across the first spindle; the first gripper 114 and the second gripper 116 placed on the first cross slide 112; the transfer arm 118. The rest of the parts of the CNC machine 102 are shown and explained in the further figures.

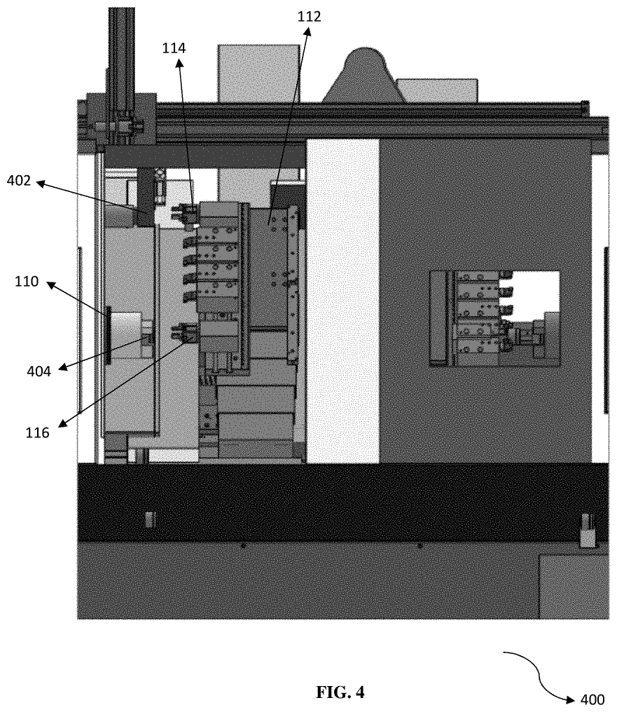

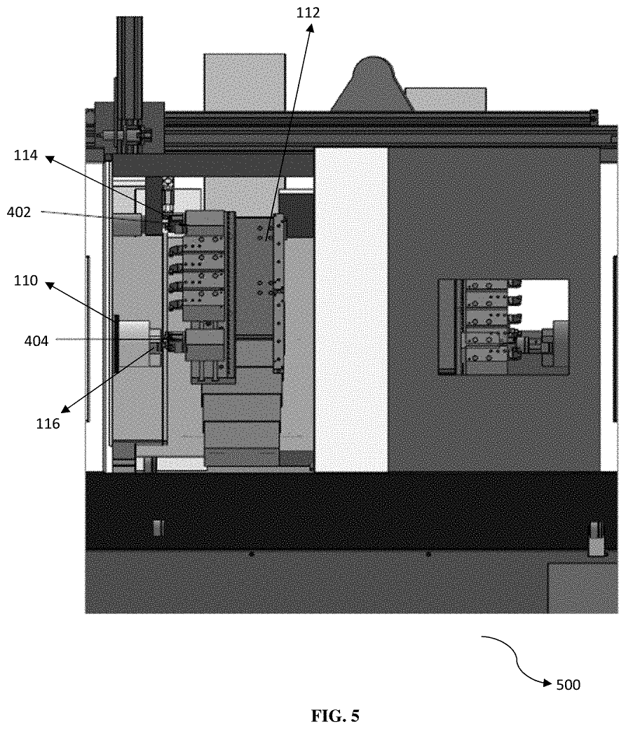

FIG. 4 shows the CNC machine 102 in an exemplary environment 400, when the first cross slide 112 is at its home position across the first spindle 110, with the twin grippers 114 and 116 at a distance from the first pickup zone 402 and the first chuck 404 of the first spindle 110. FIG. 5 shows the CNC machine 102 in an exemplary environment 500, when the grippers 114 and 116 of the first spindle 110 are operational. In this situation, the cross slide 112 slides and moves the first gripper 114 and the second gripper 116 towards the first pickup zone 402 and the first chuck 404, respectively. Thereafter, the first gripper 114 picks up the raw job that is put into the first pickup zone 402, while the second gripper 116 unloads the semi-finished job from the first chuck 404 simultaneously.

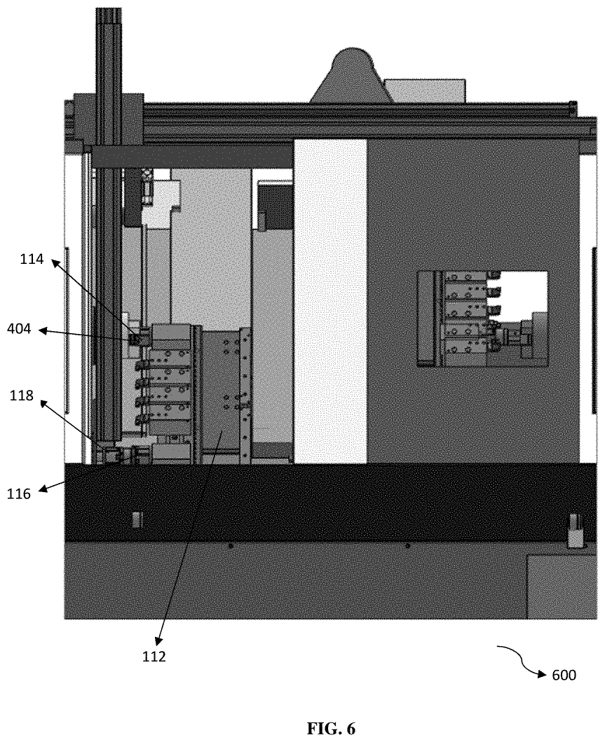

Further, after picking up the raw job and unloading the semi-finished job, the first cross slide 112 slides away from the first spindle 110. Furthermore, in the FIG. 6, the exemplary environment 600 shows the position of the first cross slide 112, when it slides back to bring the first gripper 114 close to the first chuck 404 and the second gripper 116 close to transfer arm 118. Therefore, now as shown in FIG. 6, the first gripper 114 loads the raw job onto the first chuck 404, while the second gripper 116 drops the semi-finished job into the transfer arm 118.

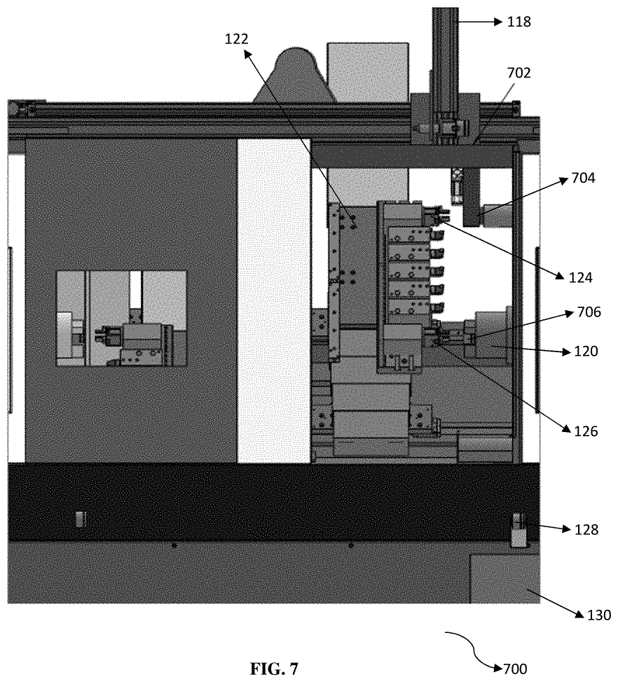

FIG. 7 shows the CNC machine 102 in an exemplary environment 700, showing the operations at the second spindle 120. As soon as the transfer arm 118 picks the semi-finished job from the second gripper 116, the transfer arm 118 travels across the CNC machine 102 and moves towards the other side where the second spindle 120 is situated. After reaching the second spindle 120, the transfer arm 118 drops the semi-finished job into the roof mounted chute 702, from where the semi-finished job reaches the second pickup zone 704 to be picked up by the third gripper 124. FIG. 7 shows the third gripper 124 and the fourth gripper 126 at their home position, with the cross slide 122 away from the second spindle 120.

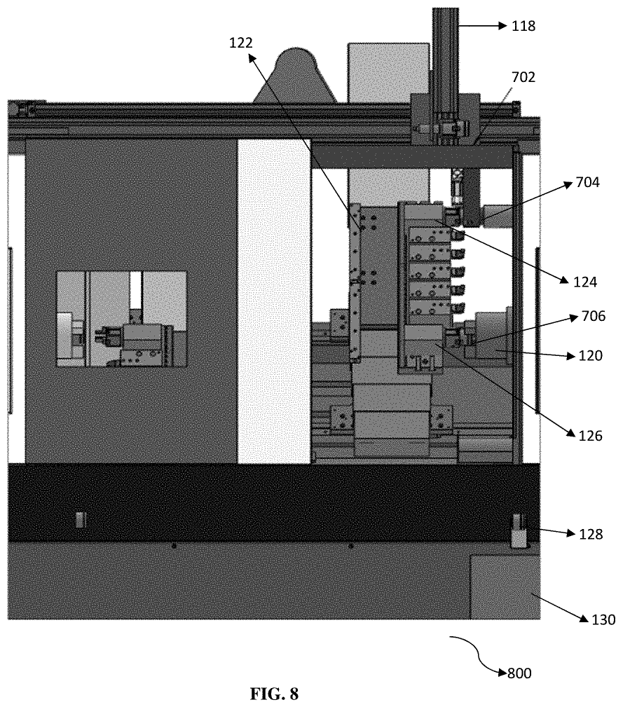

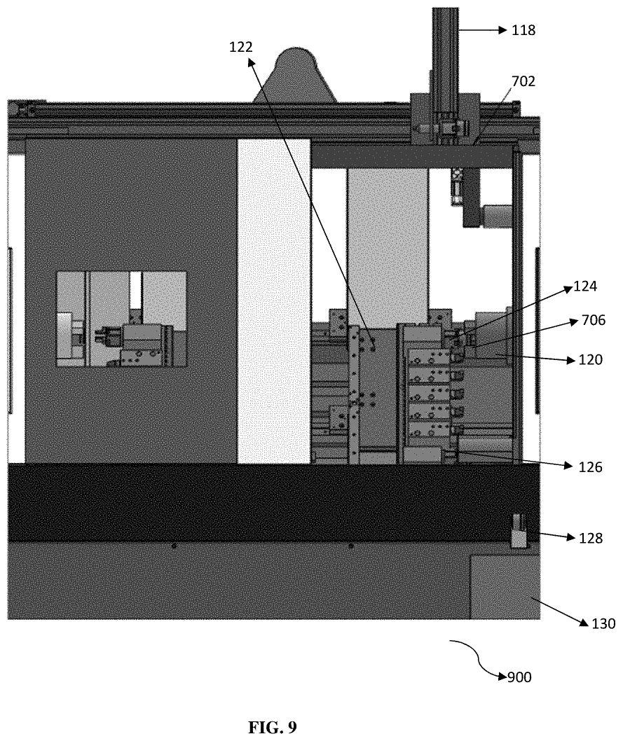

Further, FIG. 8 shows the environment 800, when the second cross slide 122 slides to bring the third gripper 124 and the fourth gripper 126 close to the second pickup zone 704 and the second chuck 706 of the second spindle 120, respectively. Thereafter, as shown in the environment 700, the third gripper 124 picks up the semi-finished job from the second pickup zone 704, while the fourth gripper 126 unloads the finished job from the second chuck 706 simultaneously. The second cross slide 122, then, moves away from the second spindle 120, slides to a position to bring the third gripper 124 and the fourth gripper 126 close to the second chuck 706 and the ejector chute 128, respectively. Furthermore, the FIG. 9 shows the exemplary environment 900, when the third gripper 124 loads the semi-finished job onto the second chuck 706, while the fourth gripper 126 drops the finished job into the ejector chute 128 simultaneously. The finished job slides through the ejector chute 128 to reach the out-feed bin 130, from the all finished jobs are collected out from the machine 102.

It may be appreciated by a person skilled in the art that the present invention may also work in the same way with multi-spindle CNC machines, more than two spindles, where each spindle has a set of twin grippers performing the job handling operations, without departing from the meaning and scope of the present invention.

Advantageously, the present invention provides an auto loading system which is simpler in design and functions faster than the conventional systems. It eliminates the need for external machines like Robot or Gantry for loading & unloading, since the present auto loading system uses the Cross Slide component of the CNC machine itself. The slide components facilitate the movement of the two sets of grippers along X-axis for loading and unloading the jobs, simultaneously, in the CNC machine. Further, the CNC machine using the present auto loading system do not have any doors for allowing the entry of robots/gantry arms, which in turn eliminates the need for door opening. Hence, the CNC machine prevents the coolant mist to be escaped from the machine enclosure. Therefore, the present invention saves space due to its simple design; saves in cost since it prevents escape of coolant mist and also eliminates use of external robots/gantry arms and complex CNC controlling parts; is easy to set-up and has low operational cost over lifetime. The auto loading system works preferably for loading and unloading of small and medium sized mass produced jobs like Rings, Bushes, Spacers, Valves, Gear Blanks, Valves, Pins etc. etc. It, further, eliminates need for human loading and unloading which is a repetitive job.

While certain embodiments have been described, these embodiments have been presented by way of example only, and are not intended to limit the scope of the present disclosure. Indeed, the novel methods, devices, and systems described herein may be embodied in a variety of other forms. Furthermore, various omissions, substitutions, and changes in the form of the methods, devices, and systems described herein may be made without departing from the spirit of the present disclosure.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed.

Also, those acts that are not dependent on other acts may be performed in parallel with the other acts. The scope of embodiments is by no means limited by these specific examples.

Numerous variations, whether explicitly given in the specification or not, such as differences in structure, dimension, and use of material, are possible. Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

I claim:

1. An automatic loading and unloading system for a double spindle CNC machine comprising:
a first cross slide (X axis), at a first spindle, installed with a first set of twin grippers including a first gripper and a second gripper, the first gripper installed at top and the second gripper installed at bottom of the first cross slide;
a second cross slide (X axis), at a second spindle, installed with a second set of twin grippers including a third gripper and a fourth gripper, the third gripper installed at top and the fourth gripper installed at bottom of the second cross slide; and
a transfer arm installed in the CNC machine such that the transfer arm is able to move between the first spindle and the second spindle;
where the first and second sets of grippers hold and move jobs within and outside the CNC machine, by performing below job handling operations:
the first cross slide maintains the first set of twin grippers at a first position where the first gripper clamps and picks a raw job from a first pickup zone, while the second gripper unloads a semi-finished job from a first chuck of the first spindle, simultaneously;
the first cross slide moves and slides the first set of twin grippers to a second position where the first gripper loads the raw job into the first chuck, while the second gripper drops the semi-finished job into the transfer arm, simultaneously;
the transfer arm travels to the second spindle and drops the semi-finished job into a second pickup zone;
the second cross slide maintains the second set of twin grippers at a third position where the third gripper clamps and picks the semi-finished job from the second pickup zone, while the fourth gripper unloads a fully finished job from a second chuck of the second spindle, simultaneously; and
the second cross slide moves and slides the second set of twin grippers to a fourth position where the third gripper loads the semi-finished job into the second chuck, while the fourth gripper drops the fully finished job into an ejector chute of the CNC machine, simultaneously.

2. The system as claimed in claim 1, wherein the fully finished job further slides through the ejector chute and lands into an out-feed bin, located outside the CNC machine, from where the fully finished job is collected out from the CNC machine.

3. The system as claimed in claim 1 also includes a rotary stacker for stacking raw jobs; a gantry arm for picking up raw job from the rotary stacker and place it on an in-feed conveyer; and the in-feed conveyer, further, feeds the raw job towards a machine chute that supplies the raw job to the first pickup zone from where it is picked by the first gripper.

4. The system as claimed in claim 1, wherein the movement of the first and second set of twin grippers in the CNC machine is controlled by the first and second cross slides respectively; and where the movements of the first and second cross slides (X axis) and the transfer arm are controlled by the CNC controller.

5. The system as claimed in claim 1, wherein the transfer arm first drops the semi-finished job in a roof mounted chute from where the semi-finished job reaches the second pickup zone.

6. The system as claimed in claim 1, wherein the first pickup zone is located above the first chuck of the first spindle, and the second pickup zone is located above the second chuck of the second spindle.

7. The system as claimed in claim 1, wherein the CNC machine may be one of a variety of CNC machines, such as Multi Axis Lathes, Multi Spindle CNC Lathes.

8. A method for automatic loading and unloading jobs in a double spindle CNC machine comprising:
maintaining a first cross slide at a first spindle, installed with a first set of twin grippers including a first gripper and a second gripper, at a first position such that the first gripper clamps and picks a raw job from a first pickup zone, while the second gripper unloads a semi-finished job from a first chuck of the first spindle, simultaneously;
moving the first cross slide for sliding the first set of twin grippers to a second position where the first gripper loads the raw job into the first chuck, while the second gripper drops the semi-finished job into a transfer arm, simultaneously;
moving the transfer arm to a second spindle and dropping the semi-finished job into a second pickup zone;
maintaining a second cross slide at a second spindle, installed with a second set of twin grippers including a third gripper and a fourth gripper, at a third position where the third gripper clamps and picks the semi-finished job from the second pickup zone, while the fourth gripper unloads a fully finished job from a second chuck of the second spindle, simultaneously; and
moving the second cross slide for sliding the second set of twin grippers to a fourth position where the third gripper loads the semi-finished job into the second chuck, while the fourth gripper drops the fully finished job into an ejector chute of the CNC machine, simultaneously; and
wherein the first gripper is installed at the top and the second gripper is installed at the bottom of the first cross slide respectively, while the third gripper is installed at the top and the fourth gripper is installed at the bottom of the second cross slide respectively; and the transfer arm is situated in the CNC machine such that the transfer arm is able to move between the first spindle and the second spindle.

9. The method as claimed in claim 8 further includes sliding of the fully finished job through the ejector chute and landing into an out-feed bin, located outside the CNC machine, from where the fully finished job is collected out from the CNC machine.

10. The method as claimed in claim 8 also includes stacking raw jobs at a rotary stacker; picking up raw job by a gantry arm from the rotary stacker and placing it on an in-feed conveyer; conveying the raw job further towards a machine chute that supplies the raw job to the first pickup zone from where it is picked by the first gripper.

11. The method as claimed in claim 8, wherein the movement of the first and second set of twin grippers in the CNC machine is controlled by the first and second cross slides (X axis) respectively; and where the movements of the first and second cross slides (X axis) and the transfer arm are controlled by the CNC controller.

12. The method as claimed in claim 8, wherein the transfer arm first drops the semi-finished job in a roof mounted chute from where the semi-finished job reaches the second pickup zone.

13. The method as claimed in claim 8, wherein the first pickup zone is located above the first chuck of the first spindle, and the second pickup zone is located above the second chuck of the second spindle.

14. The method as claimed in claim 8, wherein the CNC machine may be one of a variety of CNC machines, such as Multi Axis Lathes, Multi Spindle CNC Lathes.
